(19) United States
(12) Patent Application Publication
(10) Pub. No.: US 2011/0218257 A1
(43) Pub. Date: Sep. 8, 2011

(54) PARTICULATE, EXPANDABLE POLYMER, METHOD FOR PRODUCING PARTICULATE EXPANDABLE POLYMER, AS WELL AS A SPECIAL USE OF THE OBTAINED FOAM MATERIAL

(76) Inventors: Jan Noordegraaf, Wijchen (NL); Franciscus Petrus Antonius Kuijstermans, Sprundel (NL); Josephus Petrus Maria De Jong, Breda (NL)

(21) Appl. No.: 13/122,960

(22) PCT Filed: Oct. 5, 2009
(86) PCT No.: PCT/NL2009/050595

§ 371 Date: May 24, 2011

(30) Foreign Application Priority Data
Oct. 9, 2008 (NL) 1036039

(51) Int. Cl. C08J 9/18; C08F 12/08; C08L 25/06; C08L 67/04

(52) U.S. Cl. 521/60; 521/56; 521/146; 521/182

(57) ABSTRACT

The present invention relates to a particulate, expandable polymer, for example polystyrene (EPS) or polylactic acid (PLA) or a combination thereof, which can be processed to form a foam having a fine cell structure and a low density, and which contains a thermal insulation value-increasing material so as to increase the thermal insulation value thereof The present invention further relates to a method for producing such particulate, expandable polymer, as well as to a foam material based on such a polymer.

The present invention relates to a particulate, expandable polymer which can be processed to form a foam having a fine cell structure and a low density, said polymer containing active carbon having a D10 of at most 12 micrometer as a material for increasing the thermal insulation value. The designation D10 as used herein refers to the 10^{th} percentile, indicating the particle size that 10% of the population does not exceed. This will be explained in detail hereinafter. The present invention further relates to a method for producing particulate, expandable polymer, as well as to a foam material based on the present polymer.

The present inventor's Dutch patent NL 1023638 relates to a particulate, expandable polystyrene (EPS) provided with active carbon.

A method for increasing the thermal insulation value of EPS is also known from International patent application WO 00/43442, wherein styrene polymer is melted in an extruder and is mixed at least with a blowing agent and aluminium particles substantially having a laminar shape of a dimension ranging from 1 to 15 mm, followed by joint extrusion. The amount of aluminium particles that is used is at most 6 wt. %. Following this, the extrudate is cooled and reduced to particles. Such polymers contain aluminium particles so as to enhance the thermal insulation properties thereof, with the aluminium particles being homogeneously distributed and incorporated as a material that reflects infrared radiation.

The present invention relates to polymers that can be used for obtaining foamed moulded products. The present invention in particular relates to the use of polystyrene, polylactic acid and a combination thereof.

The starting material that is used for producing expandable polystyrene (EPS) can be obtained not only via the extrusion process, as known from the aforesaid International patent application WO 00/43442, but also via suspension polymerisation. The EPS thus obtained, in the form of granulate or granules formed by means of an extrusion process, is generally used as a starting material in the packaging industry and the construction industry. Where the term “granules” is used in the description below, this can also be read as “granulate” and vice versa.

Polylactic acid (PLA) is a generic term for polymers based on lactic acid monomers, in which the structure of polylactic acid can vary from fully amorphous to semi-crystalline or crystalline, depending on the composition. Polylactic acid can be produced from milk products or from maize, for example. Lactic acid is the monomer of which polylactic acid is built up, and this monomer occurs in two stereo isomers, viz. L-lactic acid and D-lactic acid. Polylactic acid thus contains a certain amount of L-lactic acid monomers and a certain amount of D-lactic acid monomers. The ratio between the L- and D-lactic acid monomers in polylactic acid determines the properties thereof. The terms D-value or D-content (percentage of D-lactic acid monomers) are also used. Currently commercially available polylactic acid comprises a ratio L:D of 100:0 to 75:25; in other words, a D-content of 0 to 25%, or between 0 and 0.25.

The method for the further processing of EPS granules comprises a so-called pre-foaming treatment, in which an specific amount of steam is passed through a layer of polymer granules in an expansion vessel, causing the blowing agent that is present in the polymer granules (usually pentane), to evaporate, resulting in foaming of the granules. After a storage period of about 4-48 hours, also referred to as “setting”, the granule thus pre-foamed is introduced into a substantially fitting mould, in which the granules are further caused to expand under the influence of steam. The desired moulded product is obtained in that the pre-foamed granules further expand under the influence of steam and also fuse into one moulded product.

An example of the further processing of PLA granulate is the following. After impregnation with for example 6-8% CO₂, PLA granulate is foamed at a pressure of for example 20 bar. The PLA is then impregnated anew as a foam with, for example, 6% CO₂ and formed in a mould, using a steam pressure of 0.2 to 0.5 bar. This results in the moulded product being obtained in a similar manner as described above with regard to EPS granules.

The mould used in the above methods is provided with small apertures, so that the remaining blowing agent and possibly steam can escape during the expansion process whilst the granules fuse together to the desired shape. The dimension and shape of this mould is in principle not bound by limitations, making it possible to obtain blocks for the construction industry as well as meat dishes or fish boxes, for example.

In the production of EPS-granules via the above-described polymerisation process, a particle size having a so-called Gauss-distribution, generally over a range from 0.2 mm to 2.5 mm, is obtained. In practice it has been found that the fraction having a particle size <0.3 mm is in fact unsuitable for regular packaging material, and that particles having a particle size <0.6 mm are not suitable for construction purposes. Although it is possible within certain bounds to influence the particle size during the suspension polymerisation, in principle there will always be a certain amount of residual fractions, viz. small particles having a particle size <0.3 mm and large particles having a particle size >2.4 mm, which large particles are also undesirable for the aforesaid use.

Since such residual fractions still contain valuable materials, a method for recycling said materials in an extruder was already developed previously by the present inventor. The starting material, viz. residual fraction having a small or a large particle size, is fed to the extruder, with the blowing agent fully exiting the starting material during extrusion, being discharged via a vent port connected to the extruder and combusted in an integrated post-combustion process, during which steam may be generated. The granulate, from which the blowing agent has thus been removed, is discharged from the extruder via a heated extrusion head and chopped into small particles. A problem that occurs in such a recycling process is that the EPS granules comprise fire retardants in addition to blowing agent, which fire retardants start to decompose at the temperatures that prevail in the extruder, resulting in halogen radicals, as a result of which the chain length of polystyrene is undesirably decreased. Moreover, as a result of the formation of halogen gas, this may furthermore lead to corrosion of the extruder. The residual fractions are thus not recycled as 100% material, i.e. the residual fractions are mixed with new material.

PLA-granules are formed by so-called head chopping from an extrusion device. To that end, solid PLA is charged to an extrusion device and melted. Subsequently, the melted PLA is forced through a die, for example a so-called underwater granulator, and the PLA-granules are formed by so-called head chopping. According to another possibility, liquid PLA from an in-line polymerisation process, which thus does not need to be melted first, is delivered directly to the extrusion device. Preferably, a twin-screw extruder is used as the extrusion device. In an extrusion device, the polylactic acid or the mixture of polylactic acid and possibly one or more other biodegradable polymers with possibly one or more of chain extender, nucleating agent and lubricant can be processed to form particles. Such particulate polylactic acid is also described in the present inventors' PCT/NL2008/000109.

Following the extrusion of the polylactic acid, a blowing agent is added by impregnation of the PLA-granules so as to obtain expandable PLA (EPLA). Examples of blowing agents that may be used include CO₂, MTBE, nitrogen, air, (iso-)pentane, propane, butane and the like, or one or more combinations thereof. According to the first method, the polylactic acid is formed into particles, for example by means of an extrusion process, which particles are subsequently rendered expandable by impregnation with a blowing agent. According to the second method, the polylactic acid is mixed with a blowing agent, which is subsequently directly formed into expandable particles, for example by means of an extrusion process.

A first aspect of the present invention is to provide a particulate, expandable polymer, wherein polymer foam is obtained after further processing, which foam has a sufficiently low heat conduction coefficient that is desired in practice, thus making it possible to use the foam for realising the intended thermal insulation properties.

A further aspect of the present invention is to provide a particulate, expandable polystyrene (EPS), wherein EPS foam is obtained after further processing, which foam has a sufficiently low thermal conduction coefficient that is desired in practice, thus making it possible to use the foam for realising the intended thermal insulation properties.

Another aspect of the present invention is to provide a particulate, expandable polylactic acid (EPLA), wherein EPLA foam is obtained after further processing, which foam has a sufficiently low thermal conduction coefficient that is desired in practice, thus making it possible to use the foam for realising the intended thermal insulation properties.

Another aspect of the present invention is to provide a particulate, expandable mixture of polystyrene and polylactic acid (EPS-EPLA), wherein EPS-EPLA foam is obtained after further processing, which foam has a sufficiently low heat conduction coefficient that is desired in practice, making it possible to use the foam for realising the intended thermal insulation properties.

Another aspect of the present invention is to provide a method for producing expandable polymer, wherein polymer can be converted in the presence of one or more additional components into a material which, after foaming and moulding, has a higher thermal insulation value.

Another aspect of the present invention is to provide of a method for producing expandable polymer, wherein the polymer granulate has a density of about 1000 kg/m³ and, after foaming or expanding, a density of less than 100 kg/m³.

Yet another aspect of the present invention is to provide a particulate expandable polymer foam which, in its final form after foaming and moulding, also meets the fire resistance requirements according to the B2-test, viz. DIN 4102, part 2.

The present inventors have carried out extensive research into the properties of various expandable polymer particles and various kinds of active carbon. After said extensive research into the best combination of good structural and good thermal insulation properties, the present inventors surprisingly came to the discovery that the thermal insulation value can be further increased in relation to that which is described in NL 1023638 through precise control of the particle size distribution of the active carbon used for increasing the thermal insulation value. So far such a precise control of the particle size distribution has not been described yet for expandable polymers.

The particle size distribution in fine powders in general is of major importance. So far, however, the importance of the particle size distribution in the use according to the present invention was not known and has been determined by the inventors. Examples where the particle size distribution is important are the control of powder flow, surface area and consequently absorption of, for example, oil war gas, as well as activity in the case of finely distributed catalysts and the like, and of course in case of possible dangers.

Because the importance of particle size distribution in fine powders was in general already recognised, various instruments were developed specifically for measuring said particle size distribution in fine powders, for example by Malvern Instruments with the products Mastersizer and Lazersizer. Such a measurement can also be carried out with a Coulter counter from Coulter Electronic Ltd. The use of such instruments in determining the particle size distribution is well known to those skilled in the art (see for example WO 1994/029383 and WO 1996/1011962). Using the aforesaid instruments, the size of every one of a large number of particles is measured separately. Subsequently, the population of each size is plotted against the size in a diagram so as to obtain a so-called distribution curve. On the other hand, the data may also be plotted in a diagram as a so-called cumulative distribution curve. With such a cumulative distribution curve, the fraction of the sample having a size smaller than a predetermined size is plotted against said size. From such a cumulative distribution curve, the D10 (the size that 10% of the population does not exceed), the D50 (the size that half of the population does not exceed) and the 090 (the size that 90% of the population does not exceed) can be derived in a simple manner, and said three values (D10. D50 and D90) are frequently used by persons skilled in this field for characterising the particle size distribution in powder. In particular the ratio (D90-D10)/D50 (also called particle size distribution) provides a good indication as regards the distribution of the sizes present in the powder. Said particle size distribution provides additional information which is highly valuable in characterising the powder in comparison with only the median (viz. the D50).

The present invention relates to a particulate, expandable polymer as described in the opening paragraph, wherein the particle size distribution of the active carbon is according to the following formula:

$$particlesizedistrbution = \frac{( D 90 - D 10 )}{D 50} \leq 2 , 0$$

wherein D10, D50 and D90 are the 10^{th}, 50^{th} and 90^{th} percentile, respectively, indicating in a curve of the cumulative particle size the particle sizes when the accumulated amounts of the particles are 10%, 50%, and 90%, respectively.

In other words, the 10^{th} percentile is the particle size where 10% of the particles are smaller than or equal to said value, and 90% of the particles are larger, therefore.

In other words, the 50^{th} percentile is the particle size where 50% of the particles are smaller than or equal to said value, and 50% of the particles are larger, therefore.

In other words, the 90^{th} percentile is the particle size where 90% of the particles are smaller than or equal to said value, and 10% of the particles are larger, therefore.

Without being bound to a particular theory, the present inventors think that as a result of the controlled and finer particle size distribution of the active carbon, more active carbon particles are available in the wall of the polystyrene cells for effecting adsorption or reflection of incident radiant heat and thus increasing the thermal insulation value.

One or more aspects of the present invention are accomplished by using active carbon having a specific particle size distribution as the material that increases the thermal insulation value.

The desired particle size distribution as required in the present invention, viz. a particle size smaller than or equal to 2.0, is not easy to obtain. Such a narrow particle size distribution requires the special processing and grinding of the starting material of the active carbon as commercially available. The powders as for example used in NL 1023638 are types which are commercially available, and said types contain significant amounts of larger particles. At least 10% of the particles are larger than 40 micrometer. Such powders would thus not comply with a particle size distribution as narrow as that of the present invention. The powders used in the present invention contain a much smaller amount of coarse particles, since said coarse particles have been removed through elimination, for example screening. The removal of said coarse particles and thus the reduction of the particle size distribution is an essential feature of the present invention and important to the improved efficiency of the active carbon in reducing heat transmission by the foamed materials according to the present invention.

The polymer granulate obtained according to the present invention has a density in the 850-1300 kg/m³ range, wherein, after expansion, a material having a density in the 9-100 kg/m³ range, in particular in the 15-30 kg/m³ range, is obtained.

To obtain a particulate, expandable polymer comprising the means for increasing the thermal insulation value thereof, it is in particular desirable if the active carbon has a D10 of at most 12 micrometer, in particular a D10 of at most 8 micrometer, in particular a D10 of at most 5 micrometer, more in particular 3 micrometer or even 2 micrometer.

In a special embodiment it is desirable if the amount of active carbon amounts to 1-15 wt. %, based on the polymer, the amount of active carbon preferably amounts to 2-10 wt. %, more in particular the amount of active carbon amounts to 3-8 wt. %, based on the polymer. If the amount of active carbon is less than 1 wt. %, an insufficient increase of the thermal insulation value is obtained. In those cases in which an amount higher than 15 wt. % is used, no additional thermal insulation effect is observed, but the structural properties decrease undesirably.

In a preferred embodiment of the present invention, the polymer is polystyrene. This is understood to mean that at least 80 wt. %, preferably at least 90 wt. %, in particular at least 99 wt. % and more in particular 100 wt. %, of the particulate polymer is polystyrene.

In a preferred embodiment of the present invention, the polymer is polylactic acid. This is understood to mean that at least 80 wt. %, preferably at least 90 wt. %, in particular at least 99 wt. % and more in particular 100 wt. % of the particulate polymer is polylactic acid.

In a preferred embodiment of the present invention, the polymer is a combination of polylactic acid and polystyrene. This is understood to mean that at least 80 wt. %, preferably at least 90 wt. %, in particular at least 99 wt. % and more in particular 100 wt. % of the particulate polymer is a combination of polylactic acid and polystyrene, in any desired ratio.

Especially preferred is an embodiment in which the particle size distribution of the active carbon is smaller than or equal to 1.8, preferably smaller than or equal to 1.6. Such a distribution leads to a more uniform distribution of the active carbon in the polymer particles.

It should be understood that in specific embodiments the additional presence of one or more other thermal insulation value-increasing agents selected from the group of graphite, aluminium powder, Al(OH)₃, Mg(OH)₂ and Al₂O₃, iron, zinc, copper and alloys thereof in particulate expandable polystyrene may be desirable.

Using the present method, it has been found to be possible to process polymer having a particle size <0.3 mm in an extruder without any problems worth mentioning. In specific embodiments it is on the other hand also possible to use polymer having a particle size >2.4 mm. It is of course also possible to process intermediate particle sizes by means of an extrusion process.

In a specific embodiment it is desirable to obtain polymer having a particle size of 0.7-1.0 mm, in particular a particle size of 1.0-2.4 mm, preferably a particle size of 1.0-1.5 mm.

To obtain expandable polystyrene (EPS) exhibiting an adequate fire retardancy, it is preferable if the polymer contains a fire retardant, in particular hexabromocyclododecane (HBCD), before the extrusion takes place.

If the product obtained after extrusion is to meet stringent fire safety requirements, it is desirable that one or more fire retardants selected from the group consisting of hexabromocyclododecane (HBCD), dicumyl peroxide and 2,3-dimethyl-2,3-diphenyl butane are separately fed to the extruder during the extrusion process, with the amount thereof ranging between 1.0 and 8 wt. %, based on the amount of EPS polymer.

In a preferred embodiment of the present invention, the polylactic acid comprises a chain extender, for example selected from the group consisting of polyepoxides and diepoxides (Joncryl 4368C from supplier BASF) di-isocyanates, oxazines and oxazolines, cyclic dianhydrides (for example PMDA), peroxides (for example Trigonox types from Akzo Nobel) and the like. Such a chain extender is added to increase the melting strength of the polylactic acid. Examples of such a chain extender include Joncryl 4368C from supplier BASF. Zinc stearate may be added as a catalyst of the chain extender.

In another embodiment of the present invention, the polylactic acid also comprises a nucleating agent or foam nucleating agent, preferably selected from the group consisting of polyolefin wax, such as polyethylene wax or polypropylene wax, for example, or talcum or nano clay. The foam quality is improved by the addition of such a nucleating agent. An example of this is Polywax P3000 from Baker Hughes Corp.

In yet another further preferred embodiment of the present invention, the polylactic acid also comprises a lubricant, for example selected from the group consisting of zinc stearate or other metal salts or stearates. Said lubricant functions as an external lubricant. If zinc stearate is selected, it can also function as a catalyst of the chain extender.

The particle size of the particulate polylactic acid preferably ranges between 0.5 mm and 5 mm. A particle size of less than 0.5 mm is very difficult to obtain without losing the desired properties, and a particle size of more than 5 mm results in less favourable foam properties on account of the reduced ratio between surface area and volume of the particle. The particle size in particular ranges between 0.5 mm and 1.5 mm because of the optimum foam properties.

The present invention further relates to a method for producing particulate expandable polymer, wherein polymer is fed to an extruder, mixed with at least a blowing agent and active carbon having a D10 of at most 12 micrometer and subsequently extruded, cooled and further reduced to particles, wherein particle size distribution of the active carbon is according to the following formula:

$$particlesizedistribution = \frac{( D 90 - D 10 )}{D 50} \leq 2 , 5$$

wherein D10, D50 and D90 are the 10^{th}, 50^{th} and 90^{th} percentile, respectively, indicating in a curve of the cumulative particle size the particle sizes when the accumulated amounts of the particles are 10%, 50%, and 90%, respectively.

The present invention also relates to a method for producing particulate expandable polymer, wherein polymer is fed to an extruder and mixed with active carbon having a D10 of at most 12 micrometer, and is then extruded, cooled and further reduced to particles and subsequently subjected to an impregnation treatment with blowing agent so as to obtain a material which is cooled and which contains blowing agent, wherein the particle size distribution of the active carbon is according to the following formula:

$$particlesizedistribution = \frac{( D 90 - D 10 )}{D 50} \leq 2 , 5$$

wherein D10, D50 and D90 are the 10^{th}, 50^{th} and 90^{th} percentile, respectively, indicating in a curve of the cumulative particle size the particle sizes when the accumulated amounts of the particles are 10%, 50%, and 90%, respectively.

The embodiments of the particulate, expandable polymer mentioned in the description and the claims also apply to the methods for producing the same, and vice versa.

There are no limitations as regards the manner of adding the active carbon. It can for example be done by adding the same as a powder or carried on a carrier, for example on polystyrene or a copolymer of polystyrene and other polymers, for example acrylate polymer. The advantage of active carbon carried on a carrier is that it is easier to process, since it does not exhibit the dust formation that active carbon powder as such exhibits.

The active carbon can be added at various moments during the process of preparing the particulate, expandable polymer. It can for example be added simultaneously with polymer granules in the feed hopper of the extruder. It can furthermore be added just before extrusion by a side feed unit. In addition to that it can be added in the extrusion chamber itself. It may also be added in a so-called in-line polymerisation unit (as for example marketed by BASF), for example by a side feed unit.

The present invention further relates to a polymer foam material based on particulate, expandable polymer as described in the foregoing, wherein the polymer foam material is preferably used for thermal insulation purposes.

After expansion, the present foam material preferably has a density ranging between 9 and 100 kg/m³, in particular 15-30 kg/m³.

The invention will be explained hereinafter by means of a number of examples and comparative examples, in which connection it should be noted, however, that the present invention is by no means limited to such examples.

### EXAMPLES

De present inventors subjected the active carbon as used in NL 1023638, being active carbon ground on a ball mill, to measurements regarding the particle size distribution. Furthermore, the 50^{th} and the 90^{th} percentile were determined, viz. the particle size where 50% and 90%, respectively, of the particles are smaller than or equal to said value. The term “particle size” as used in NL 1023638 relates to the D10 particle size or, in other words, the 10^{th} percentile. The details regarding the active carbon types used are shown in Table 1.

The active carbon used in the present invention has an altogether different, much narrower particle size distribution, which is shown below in Table 1.

TABLE 1

| | | | | particle size |
|---|---|---|---|---|
| | | | | distribution |
| | 10^{th} | 50^{th} | 90^{th} | (D90-D10) |
| Type | percentile | percentile | percentile | D50 |
| Type A according to | 2 | 6 | 40 | 6.3 |
| NL1023638¹⁾ | | | | |
| Type B according to | 3 | 7 | 43 | 5.7 |
| NL1023638¹⁾ | | | | |
| Type C according to | 10 | 20 | 60 | 2.5 |
| NL1023638¹⁾ | | | | |
| Type 1 according to invention²⁾ | 2 | 5 | 10 | 1.6 |
| Type 2 according to invention³⁾ | 3 | 5 | 10 | 1.4 |
| Type 3 according to invention⁴⁾ | 2 | 4 | 8 | 1.5 |
| Type 4 according to invention⁵⁾ | 2 | 4 | 8 | 1.5 |
| Type 5 according to invention⁶⁾ | 2 | 5 | 8 | 1.2 |

¹⁾active carbon of Norit GL 50 ground on ball mill
²⁾active carbon 59% on a carrier, viz. a copolymer of polystyrene and acrylate (HCA, Apeldoorn, type 60-10-15712)
³⁾active carbon 59% on a carrier, viz. a copolymer of polystyrene and acrylate (HCA, Apeldoorn, type 60-10-15717)
⁴⁾Active carbon (Norit, type PAC BC)
⁵⁾Active carbon (Norit, type PAC BC) 35% carried on polystyrene as the carrier (Synbra technology B.V. polystyrene type GPPS)
⁶⁾graphite (Krofmuhl, type UF2 96/97)

The obtained polymer particles provided with active carbon were formed into a moulded product by means of a foaming process with a specific density of for example 30, 20 or 15 gram/litre, which moulded product was subjected to a test for determining the lambda value according to EN-12939. As the lambda values decrease (towards 0.0300), the differences become smaller and less easy to measure. Small deviations in the measuring results can occur with such low values, which deviations are not observed, or to a lesser extent, at higher values of around 0.0330. In addition to that, the moulded product was subjected to a combustibility test, viz. the B2-test, measured according to DIN 4102, part 2.

### Comparative Examples

### Comparative Example 1

Blowing agent, styrene polymer, 0.8 wt. % hexabromocyclododecane (HBCD) and 0.3 wt. % dicumyl peroxide were supplied to an extruder, whilst an amount of 2.0 wt. % active carbon type C having an average particle size (D10; 10^{th} percentile) of 10 micrometer was co-extruded so as to increase the thermal insulation value. This example corresponds to Example 1 of NL 1023638. The obtained results are summarized in Table 2 below.

### Comparative Example 2

The same operations as described in Comparative Example 1 were carried out, except that the amount of active carbon type C was increased to 5.0 wt. %. This example corresponds to Example 2 of NL 1023638.

### Comparative Example 3

The same operations as described in Comparative Example 1 were carried out, except that the amount of active carbon type C was increased to 8.0 wt. %. This example corresponds to Example 3 of NL 1023638.

### Comparative Example 4

The same operations as described in Comparative Example 1 were carried out, except that the active carbon type B was added in an amount of 2.0 wt. % and having a particle size (D10; 10^{th} percentile) of 3 micrometer. This example corresponds to Example 7 of NL 1023638.

### Comparative Example 5

The same operations as described in Comparative Example 4 were carried out, except that the amount of active carbon type B was increased to 5.0 wt. %. This example corresponds to Example 8 of NL 1023638.

### Comparative Example 6

The same operations as described in Comparative Example 4 were carried out, except that the amount of active carbon type B was increased to 8.0 wt. %. This example corresponds to Example 9 of NL 1023638.

### Comparative Example 7

The same operations as described in Comparative Example 4 were carried out, except that the amount of active carbon type B was increased to 10.0 wt. %. This example corresponds to Example 10 of NL 1023638.

### Comparative Example 8

The same operations as described in Comparative Example 1 were carried out, except that an amount of 2.0 wt. % active carbon type A having a particle size (D10; 10^{th} percentile) of 2 micrometer was co-extruded. This example corresponds to Example 11 of NL 1023638.

### Comparative Example 9

The same operations as described in Comparative Example 8 were carried out, except that the amount of active carbon type A was increased to 5.0 wt. %. This example corresponds to Example 12 of NL 1023638.

### Comparative Example 10

The same operations as described in Comparative Example 5 were carried out, except that the particulate, expandable polystyrene was obtained by means of an extrusion process, with the metering of blowing agent, in particular pentane, taking place via the suspension route. This example corresponds to Example 17 of NL 1023638.

### Comparative Example 11

Lactic acid polymer, type Hisun expansion grade PLA, impregnated with 5.5% blowing agent CO₂ was supplied to an extruder. An agent for increasing the thermal insulation value was not added.

### Examples

### Example 1

The same operations as described in Comparative Example 1 were carried out, except that an amount of 3.0 wt. % active carbon type 4 according to the invention having a particle size (D10; 10^{th} percentile) of 2 micrometer and a particle size distribution of 1.5 was co-extruded.

### Example 2

The same operations as described in Example 1 were carried out, except that active carbon was co-extruded in an amount of 2.0 wt. %.

### Example 3

The same operations as described in Example 1 were carried out, except that active carbon type 3 having a particle size (D10; 10^{th} percentile) of 2 micrometer and a particle size distribution of 1.5 was used in an amount of 5.0 wt %. The active carbon was co-extruded as a powder.

### Example 4

The same operations as described in Example 3 were carried out, except that the amount of active carbon was increased to 6.0 wt. %.

### Example 5

The same operations as described in Example 3 were carried out, except that the amount of active carbon was increased to 7.0 wt. %.

### Example 6

Lactic acid polymer, type Hisun expansion grade PLA, impregnated with 5.5% blowing agent CO₂ was added to an extruder. An amount of 3.0 wt. % active carbon type 3 having a particle size (D10, 10^{th} percentile) of 2 micrometer and a particle size distribution of 1.5 was co-extruded as an agent for increasing the thermal insulation value.

### Example 7

The same operations as described in Example 6 were carried out, except that the active carbon was co-extruded in an amount of 4.0 wt. %.

### Example 8

The same operations as described in Example 6 were carried out, except that the active carbon was co-extruded in an amount of 9.0 wt. %.

### Example 9

The same operations as described in Example 8 were carried out, except that active carbon type 5 having a particle size (D10; 10^{th} percentile) of 2 micrometer and a particle size distribution of 1.2 was used in an amount of 5.0 wt. %.

### Example 10

The same operations as described in Example 6 were carried out, except that the active carbon was co-extruded in an amount of 7.0 wt. %.

### Example 11

Styrene polymer and lactic acid polymer Hisun expansion grade (in a ratio of 95:5) impregnated with 5.5% CO₂ as a blowing agent were added to an extruder, whilst active carbon type 3 having a D10 of 2 micrometer was co-extruded in an amount of 5.0 wt. % as an agent for increasing the thermal insulation value.

TABLE 2

| | | | | Lambda | Lambda | | | |
|---|---|---|---|---|---|---|---|---|
| | | wt. % | type of | value | value | | D10 particle size | |
| | | active | active | W/mK, | W/mK, | B2- | (particle size | |
| Example | polymer | carbon | carbon | 15 g/l | 20 g/l | test | distribution) | |
| Comparative | PS | 2 | C | n.d. | 335 | n.d. | 10 | (2 5) |
| Example 1 | | | | | | | | |
| Comparative | PS | 5 | C | n.d. | 32 | n.d. | 10 | (2.5) |
| Example 2 | | | | | | | | |
| Comparative | PS | 8 | C | n.d. | 32 | Yes | 10 | (2.5) |
| Example 3 | | | | | | | | |
| Comparative | PS | 2 | B | n.d. | 33 | n.d. | 3 | (5.7) |
| Example 4 | | | | | | | | |
| Comparative | PS | 5 | B | 33 | 3 | n.d. | 3 | (5.7) |
| Example 5 | | | | | | | | |
| Comparative | PS | 8 | B | 32 | 3 | n.d. | 3 | (5.7) |
| Example 6 | | | | | | | | |
| Comparative | PS | 10 | B | 32 | 295 | yes | 3 | (5.7) |
| Example 7 | | | | | | | | |
| Comparative | PS | 2 | A | n.d. | 33 | n.d. | 2 | (6.3) |
| Example 8 | | | | | | | | |
| Comparative | PS | 5 | A | 33 | 305 | yes | 2 | (6.3) |
| Example 9 | | | | | | | | |
| Comparative | PS | 5 | A | n.d. | 32 | yes | 2 | (6.3) |
| Example 10 | | | | | | | | |
| Comparative | PLA | — | — | 35 | 33 | n.d. | — | |
| Example 11 | | | | | | | | |
| Example 1 | PS | 3 | 4 | 312 | 302 | yes | 2 | (1.5) |
| Example 2 | PS | 2 | 4 | 333 | 323 | yes | 2 | (1.5) |
| Example 3 | PS | 5 | 3 | 318 | 308 | yes | 2 | (1.5) |
| Example 4 | PS | 6 | 3 | 319 | 309 | yes | 2 | (1.5) |
| Example 5 | PS | 7 | 3 | 316 | 306 | yes | 2 | (1.5) |
| Example 6 | PLA | 3 | 3 | 324 | 305 | n.d. | 2 | (1.5) |
| Example 7 | PLA | 4 | 3 | 305 | 3 | n.d. | 2 | (1.5) |
| Example 8 | PLA | 5 | 3 | 31 | 3 | n.d. | 2 | (1.5) |
| Example 9 | PLA | 5 | 5 | 305 | 3 | n.d. | 2 | (1.2) |
| Example 10 | PLA | 7 | 3 | 316 | 301 | n.d. | 2 | (1.5) |
| Example 11 | PS/PLA | 5 | 3 | 317 | 305 | n.d. | 2 | (1.5) |

n.d. = not determined

From Table 2 it appears that when active carbon having a particle size D10 of 2 micrometer was added to PS in an amount of 2.0 wt. %, the lambda value for Comparative Example 8 (particle size distribution: 6.3) was 0.0330 W/mK with 20 g/l, whilst said value was 0.0323 W/mK when using the active carbon type 4 according to Example 2 of the invention (particle size distribution: 1.5). An improvement of 0.007 W/mK achieved by using active carbon having a particle size distribution according to the present invention.

From Table 2 it also appears that when active carbon having a particle size D10 of 2 micrometer was added in an amount of 5.0 wt. %, the lambda values for Comparative Example 9 (particle size distribution 6.3) were 0.0330 W/mK with 15 g/l and 0.0305 W/mK with 20 g/l, whilst these values were 0.0318 and 0.0308, respectively, when using the active carbon according to Example 3 (particle size distribution 1.5). An improvement of 0.012 W/mK with a density of 15 g/l and a value within the significance range, and thus remaining substantially constant, with 20 g/l.

From Table 2 it appears that particulate, expandable polystyrene polylactic acid and a combination exhibiting an increased thermal insulation value is obtained if active carbon having the present particle size distribution, i.e. smaller than or equal to 2.0, preferably smaller than or equal to 1.5, in particular smaller than or equal to 1.2, is used. Very good results are obtained if also the particle size (D10, 10^{th} percentile) is further reduced, in particular to a value of 5 or 3 or even 2 micrometer. From the above table it furthermore follows that the amount of active carbon is preferably 1-15 wt. %, in particular 2-10 wt. %, more in particular 3-8 wt. %, based on polymer.

Further embodiments are defined in the appended claims.

| | | | | Lambda- | Lambda- | |
|---|---|---|---|---|---|---|
| | | wt. % | type | value | value | |
| | | active | active | W/mK, | W/mK, | B2- |
| Example | polymer | carbon | carbon | 15 g/l | 20 g/l | test |
| Comparative | | 2.0 | C | | 335 | |
| Example 1 | | | | | | |
| Comparative | ps | 5.0 | C | | 320 | |
| Example 2 | | | | | | |
| Comparative | ps | 8.0 | C | | 320 | yes |
| Example 3 | | | | | | |
| Comparative | ps | 2.0 | B | | 330 | |
| Example 4 | | | | | | |
| Comparative | ps | 5.0 | B | 330 | 300 | |
| Example 5 | | | | | | |
| Comparative | ps | 8.0 | B | 320 | 300 | |
| Example 6 | | | | | | |
| Comparative | ps | 10.0 | B | 320 | 295 | yes |
| Example 7 | | | | | | |
| Comparative | ps | 2.0 | A | | 330 | |
| Example 8 | | | | | | |
| Comparative | ps | 5.0 | A | 330 | 305 | yes |
| Example 9 | | | | | | |
| Comparative | ps | 5.0 | A | | 320 | yes |
| Example 10 | | | | | | |
| Comparative | PLA | 0.0 | — | 350 | 330 | n.d. |
| Example 11 | | | | | | |
| Example 1 | ps | 3.0 | 4 | 312 | 302 | yes |
| Example 2 | ps | 2.0 | 4 | 333 | 323 | yes |
| Example 3 | ps | 5.0 | 3 | 3180 | 308 | yes |
| Example 4 | ps | 6.0 | 3 | 3190 | 309 | yes |
| Example 5 | ps | 7.0 | 3 | 3160 | 306 | yes |
| Example 6 | PLA | 3.0 | 3 | 324 | 305 | n.d. |
| Example 7 | PLA | 4.0 | 3 | 305 | 300 | n.d. |
| Example 8 | PLA | 5.0 | 3 | 310 | 300 | n.d. |
| Example 9 | PLA | 6.0 | 5 | 305 | 300 | n.d. |
| Example 10 | PLA | 7.0 | 3 | 316 | 301 | n.d. |
| Example 11 | PS/PLA | 5.0 | 3 | 317 | 305 | n.d. |

n.d. = not determined

1. A particulate, expandable polymer which can be processed to form a foam having a fine cell structure and a low density, said polymer comprising active carbon having a particle size D10 of at most 12 micrometer for increasing the thermal insulation value, wherein the particle size distribution of the active carbon is according to the following formula:
$$particle size distribution = \frac{( D 90 - D 10 )}{D 50} \leq 2.0$$
wherein D10, D50 and D90 are the 10^{th}, 50^{m} and 90^{th} percentile respectively, indicating in a curve of the cumulative particle size the particle sizes when the accumulated amounts of the particles are 10%, 50%, and 90% respectively.

2. The particulate, expandable polymer according to claim 1, wherein the particle size distribution of the active carbon is smaller than or equal to 1.8.

3. The particulate, expandable polymer according to claim 1 wherein the active carbon has a particle size D10 of at most 8 micrometer.

4. The particulate, expandable polymer according to claim 1 wherein the polymer is polystyrene.

5. The particulate, expandable polymer according to claim 1 wherein the polymer is polylactic acid.

6. The particulate, expandable polymer according to claim 1 wherein the polymer comprises a combination of polystyrene and polylactic acid.

7. The particulate, expandable polymer according to claim 1 wherein the amount of active carbon is 1-15 wt %, based on the polymer.

8. The particulate, expandable polymer according to claim 1 wherein additionally one or more other thermal insulation value-increasing agents selected from graphite, aluminum powder Al(OH)₃Mg(OH)₂ and Al₂O₃ iron zinc copper and alloys thereof are present in the polymer.

9. A method for producing particulate expandable polymer which can be processed to form a foam having a fine cell structure and a low density, said polymer comprising active carbon having a particle size D10 of at most 12 micrometer for increasing the thermal insulation value comprising feeding a polymer to an extruder, mixing with at least a blowing agent and active carbon having a particle size D10 of at most 12 micrometer and subsequently extruded, cooled and further reduced to particles, wherein the particle size distribution of the active carbon is according to the following formula:
$$particle size distribution = \frac{( D 90 - D 10 )}{D 50} \leq 2.0$$
wherein D10, D50 and D90 are the 10^{th}, 50^{th} and 90^{th} percentile, respectively, indicating in a curve of the cumulative particle size the particle sizes when the accumulated amounts of the particles are 10%, 50%, and 90%, respectively.

10. A method for producing particulate expandable polymer which can be processed to form a foam having a fine cell structure and a low density, said polymer comprising active carbon having a particle size D10 of at most 12 micrometer for increasing the thermal insulation value comprising feeding a polymer to an extruder and mixing with active carbon having a particle size D10 of at most 12 micrometer, and is then extruded, cooled and further reduced to particles and subsequently subjected to an impregnation treatment with blowing agent so as to obtain a material which is cooled and which contains blowing agent, wherein the particle size distribution of the active carbon is according to the following formula:
$$particle size distribution = \frac{( D 90 - D 10 )}{D 50} \leq 2.0$$
wherein D10, D50 and D90 are the 10^{th}, 50^{th} and 90^{th} percentile respectively, indicating in a curve of the cumulative particle size the particle sizes when the accumulated amounts of the particles are 10%, 50%, and 90%, respectively.

11. A foam material comprising the particulate expandable polymer according to claim 1.

12. The foam material according to claim 11, wherein after expansion the foam material has a density in the 9-100 kg/m³ range.

13. The foam material according to claim 11, wherein after expansion the foam material has a density in the 15-30 kg/m³ range.

14. A method which comprises thermally insulating an article with the foam material according to claim 1.

15. The particulate, expandable polymer according to claim 1, wherein the particle size distribution of the active carbon is smaller than or equal to 1.6.

16. The particulate, expandable polymer according to claim 1, wherein the particle size distribution of the active carbon is smaller than or equal to 1.5.

17. The particulate, expandable polymer according to claim 1, wherein the particle size distribution of the active carbon is smaller than or equal to 1.2.

18. The particulate, expandable polymer according to claim 1 wherein the active carbon has a particle size D10 of at most 5 micrometer.

19. The particulate, expandable polymer according to claim 1 wherein the active carbon has a particle size D10 of at most 2 micrometer.

20. The particulate, expandable polymer according to claim 2 wherein the active carbon has a particle size D10 of at most 8 micrometer.
